(19) United States
(12) Patent Application Publication
(10) Pub. No.: US 2010/0148395 A1
(43) Pub. Date: Jun. 17, 2010

(54) BACTERIA-RESISTANT GRAB BAR

(75) Inventor: Stephen J. Gifford, III, Advance, NC (US)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: Lux Products Corporation, Mt. Laurel, NJ (US)

(21) Appl. No.: 12/336,737

(22) Filed: Dec. 17, 2008

(51) Int. Cl. B29C 39/02; A47B 95/02

(52) U.S. Cl. 264/250; 16/110.1

(57) ABSTRACT

A grab bar assembly includes an elongated metal grab bar; opposed end portions that extend from the grab bar; a mounting bracket associated with each end portion such that the grab bar may be attached to but spaced from a target surface; and a molded elastic handle extending along at least a portion of the grab bar which includes an antimicrobial agent and silicone rubber.

### TECHNICAL FIELD

This disclosure relates to grab bars, particularly to bacteria-resistant grab bars for bathroom use.

### BACKGROUND

Bathroom grab bars are well known. However, there is an ongoing need to provide grab bars that provide multiple qualities and functionality. For example, grab bars should be strong enough to withstand the application of pulling force from persons in a wide weight range such as up to 300 or 350 lbs. or more. Also, the means for mounting the grab bar to a target surface, typically which is a tile surface, should be strong as well, so that the mounting means can be secured to that target surface.

There is also the problem of high humidity in typical bathroom applications, particularly in the instances where grab bars are installed in showers. There is thus the problem of the growth of bacteria on various bathroom surfaces, including grab bars. It would accordingly be helpful to provide a grab bar that can satisfy these desirable features.

### SUMMARY

I provide grab bar assemblies that include an elongated metal grab bar; opposed end portions that extend from the grab bar; a mounting bracket associated with each end portion such that the grab bar may be attached to but spaced from a target surface; and a molded elastic handle extending along at least a portion of the grab bar which includes an antimicrobial agent and silicone rubber.

I also provide methods of producing grab bar assemblies. The steps may include forming a substantially tubular member into a grab bar having opposed end portions that extend from the grab bar such that the grab bar may be positioned adjacent to but spaced from a target surface; fixing a mounting plate to each end portion; applying a mold to at least a portion of the grab bar; introducing a mixture of silicone rubber and an antimicrobial agent into the mold; causing the mixture to cure and form an elastic handle; and removing the mold from around the elastic handle.

### BRIEF DESCRIPTION OF THE DRAWINGS

FIG. 1 is a schematic perspective view of a bacteria-resistant grab bar assembly.

FIG. 2 is a schematic top view of the grab bar assembly of FIG. 1.

FIG. 3 is an end view of the grab bar assembly shown in FIGS. 1 and 2.

FIG. 4 is a schematic perspective view of the front portion of one end of the grab bar and its mounting plate, with the decorative cover removed.

FIG. 5 is a schematic rear view of the mounting plate shown in FIG. 4.

FIG. 6 is a schematic perspective view of the grab bar assembly of FIG. 1 with the bacteria-resistant elastic handle removed.

FIG. 7 is a schematic perspective view of the grab bar shown in FIG. 6 with a mold applied to the elongated bar prior to application of the elastic handle.

### DETAILED DESCRIPTION

It will be appreciated that the following description is intended to refer to specific examples of structure selected for illustration in the drawings and is not intended to define or limit the disclosure, other than in the appended claims.

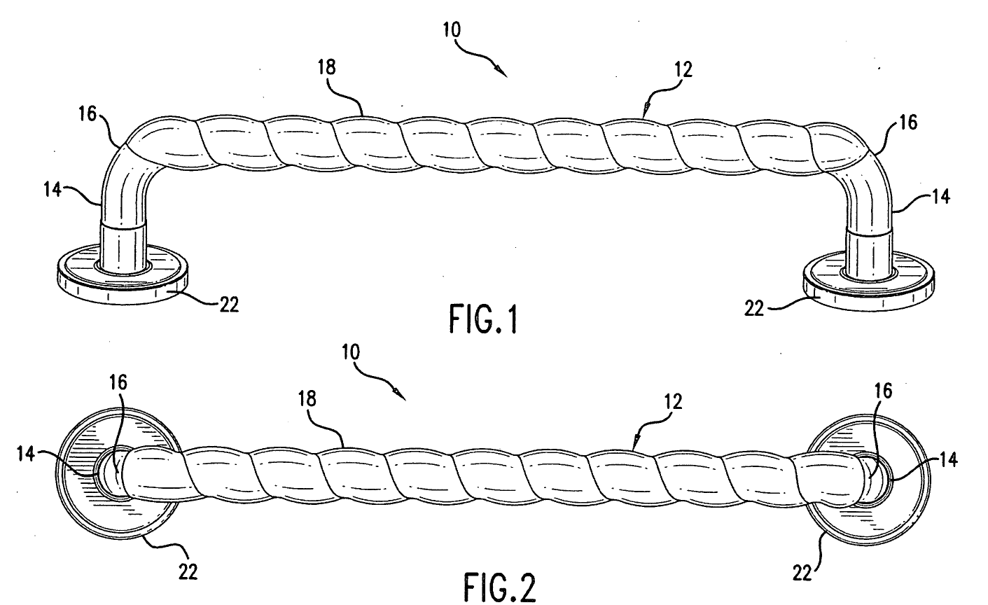

Turning now to the drawings generally and FIGS. 1 through 3 in particular, a grab bar assembly 10 is disclosed. Grab bar assembly 10 includes an elongated grab bar 12 and a pair of end portions 14. End portions 14 extend at an angle to an axis extending along elongated grab bar 12. The angle of extension of end portions 14 is substantially perpendicular or orthogonal, although other angles may be used as desired. Each end portion 14 is connected to elongated grab bar 12 at a rounded corner 16 to provide strength to the assembly 10 and a pleasant appearance. A molded elastic handle 18 extends along at least a portion of the length of elongated grab bar 12. The example shown in FIGS. 1-3 shows the molded elastic handle extending along substantially the entire length of elongated grab bar 12 and terminating at the rounded portion 16 on each end.

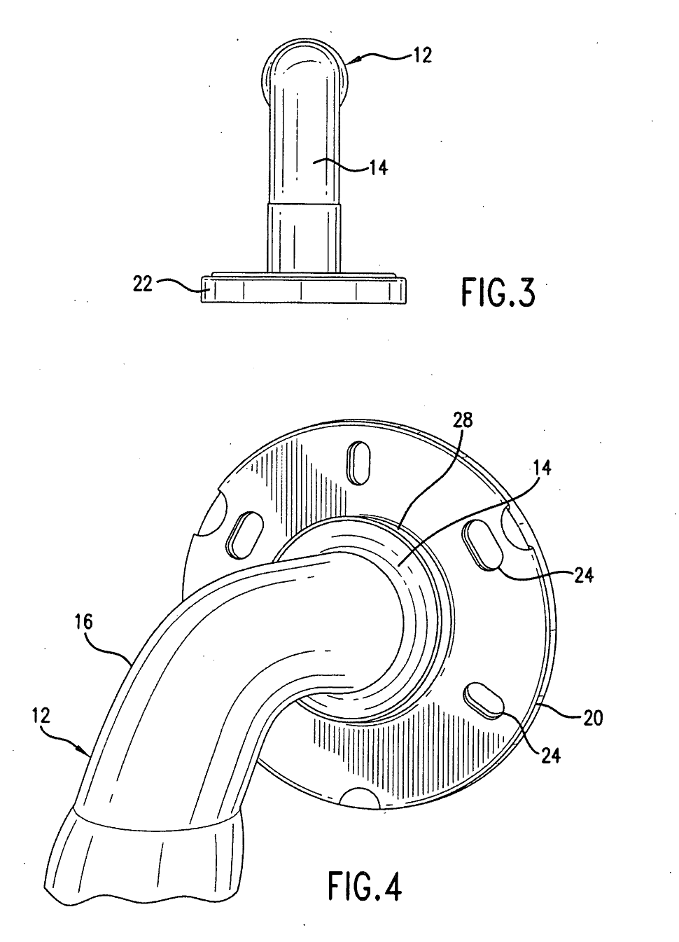

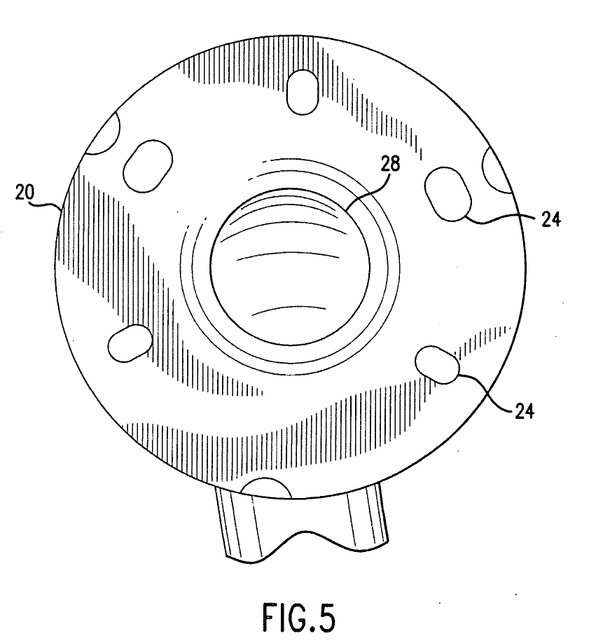

Each end portion 14 has a mounting plate 20 (shown in FIGS. 4-5) and a mounting plate cover 22. Mounting plate cover 22 completely hides mounting plate 20 after installation of grab bar assembly 10 onto a target surface to provide for a pleasant appearance. Mounting plate cover 22 is preferably removable so that grab bar assembly 10 can be removed from the target surface if desired. Any number of means for securing mounting cover 22 onto mounting plate 20 may be used such as by friction fit, clips, adhesives or the like.

FIGS. 4-5 show mounting plate 20 attached to end portion 14 of elongated grab bar 12. Mounting plate 20 has a variety of different types of openings 24 which are sized and shaped to accept any variety of screws, lag bolts, anchors and the like that may be utilized to attach mounting bar 20 to the target surface. The number, size and shape of openings 24 may be changed to suit any particular need so long as they provide for the mounting plate 20 to be strongly secured to the target surface.

FIGS. 4 and 5 show mounting plate attached to end portion 14 by a weld 28. Any number of alternative means may be used to attach mounting plate 20 to end portion 14 such as crimps, swages, brazing or the like, depending on the respective materials of mounting plate 20 and elongated grab bar 12. A particularly preferred material for both of mounting plate 20 and elongated grab bar 12 is stainless steel. However, other materials, preferably other metals may be utilized.

Molded plastic handle 18 may be comprised of a number of different materials. However, it is preferred to employ a bacteria-resistant or antimicrobial agent and silicone rubber. The antimicrobial agent and the silicone rubber may be mixed or they may be applied as separate layers. It is particularly preferred to mix the antibacterial agent with the silicone rubber. Antimicrobial agents that can be used are in particular antimicrobial metals and/or their salts. The antibacterial metals may be platinum, iridium, gold, silver and/or copper, for example. Silver is preferred. The metal salts may be metal oxides, for example. The salts that may be used are preferably sparingly soluble. The salt is preferably a sparingly soluble silver salt. A particularly preferred antimicrobial agent is nanosilver antibacterial powder which includes silver ion and type P nanometer SiO₂. Silver ion content of the antibacterial agent may span a wide variety of contents such as between about 3% and about 10%, for example.

The silicone rubber can be any number of silicone rubbers known in the art. Particularly preferred silicone rubber includes dimethylpolysiloxane, dimethylvinylsiloxy-terminated organopolysiloxane gum and silanol-terminated organopolysiloxane oil in a mixture. This forms a so-called “HTV silicone rubber.”

The antimicrobial agent and silicone rubber may be mixed in a variety of weight percentages. A weight percentage of between about 1% and about 5% of antibacterial material may be used. About 2% is particularly preferred.

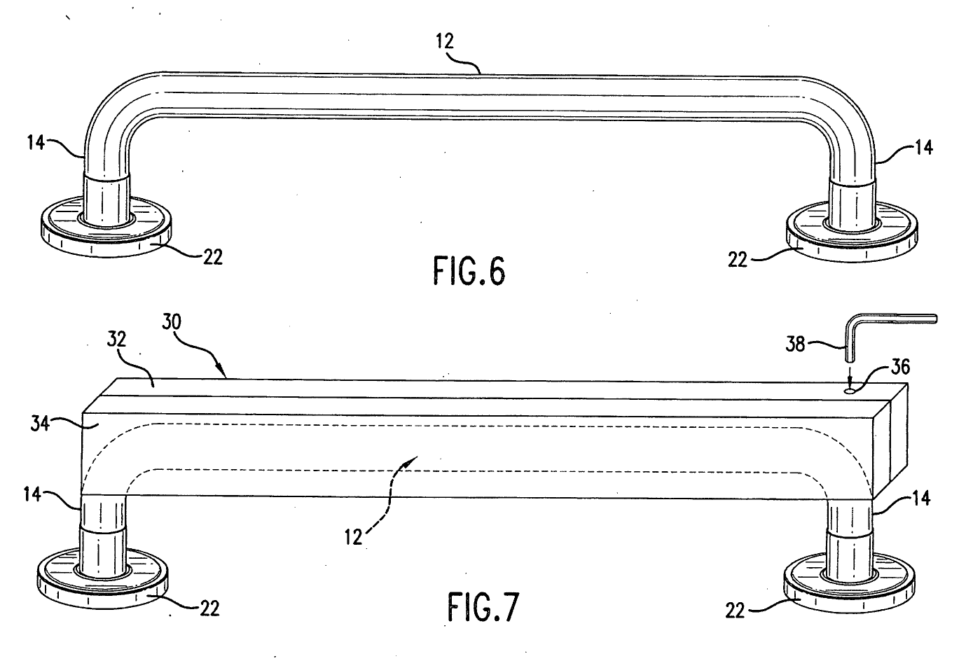

Referring now to FIGS. 6 and 7, elastic handle 18 may be formed on elongated grab bar 12 as particularly shown in FIG. 6. This may be achieved by injection molding as shown in FIG. 7. FIG. 7 shows a mold 30 applied to elongated grab bar 12. Mold 30 includes a first mold half 32 and a second mold half 34 that are applied to elongated grab bar 12 using known techniques. A mixture of silicone rubber and antimicrobial agent is introduced into mold 30 by opening 36. The mixture is supplied by means known in the art such as from a supply 38.

The interior shape of the mold may be of any type known in the art to form a variety of elastic handle shapes. However, it is preferred to have a helical, rope or braided shape such as shown in FIG. 1, for example. Depending on the materials chosen, the temperatures for the mold 30 may be varied, as well as the time required for the mold to remain in place around elongated grab bar 12. Adjusting these parameters is known to those skilled in the art. After elastic handle 18 has been appropriately formed, mold half 32 and 34 may be removed from elongated grab bar 12 and the grab bar assembly 10 is complete and ready for use.

Although the apparatus and methods have been described in connection with specific forms thereof, it will be appreciated that a wide variety of equivalents may be substituted for the specified elements described herein without departing from the spirit and scope of this disclosure as described in the appended claims.

What is claimed is:

1. A grab bar assembly comprising:
an elongated metal grab bar;
opposed end portions that extend from the grab bar;
a mounting bracket associated with each end portion such that the grab bar may be attached to but spaced from a target surface; and
a molded elastic handle extending along at least a portion of the grab bar and comprising an antimicrobial agent and silicone rubber.

2. The grab bar assembly of claim 1, wherein the grab bar is stainless steel.

3. The grab bar assembly of claim 1, wherein the opposed end portions extend substantially orthogonal to a longitudinal axis of the grab bar.

4. The grab bar assembly of claim 1, wherein the opposed ends are integral within the grab bar.

5. The grab bar assembly of claim 4, wherein the grab bar and the end portions are substantially tubular.

6. The grab bar assembly of claim 1, wherein the mounting brackets are substantially round.

7. The grab bar assembly of claim 1, wherein the antimicrobial agent contains silver.

8. The grab bar assembly of claim 1, wherein the elastic handle contains about 0.5 to about 3.0 wt % of antimicrobial agent and about 97-99.5 wt % of silicone rubber, based on the weight of the elastic handle.

9. The grab bar assembly of claim 1, wherein the elastic handle contains about 2 wt % of silver ion based on the weight of the elastic handle.

10. The grab bar assembly of claim 1, wherein the silicone rubber comprises dimethylpolysiloxane, dimethylvinylsiloxy-terminaled organopolysiloxane gum and silanol-terminated organopolysiloxane oil.

11. The grab bar assembly of claim 1, wherein at least a portion of the handle has an exterior shape that is substantially helical.

12. A method of producing a grab bar assembly comprising:
forming a substantially tubular member into a grab bar having opposed end portions that extend from the grab bar such that the grab bar may be positioned adjacent to but spaced from a target surface;
fixing a mounting plate to each end portion;
applying a mold to at least a portion of the grab bar;
introducing a mixture of silicone rubber and an antimicrobial agent into the mold;
causing the mixture to cure and form an elastic handle; and
removing the mold from around the elastic handle.

13. The method of producing a grab bar assembly in claim 12, wherein the grab bar is stainless steel.

14. The method of producing a grab bar assembly in claim 12, wherein the opposed end portions extend substantially orthogonal to a longitudinal axis of the grab bar.

15. The method of producing a grab bar assembly in claim 12, wherein the mounting brackets are substantially round.

16. The method of producing a grab bar assembly in claim 12, wherein the antimicrobial agent contains silver.

17. The method of producing a grab bar assembly in claim 12, wherein the elastic handle contains about 0.5 to about 3.0 wt % of antimicrobial agent and about 97-99.5 wt % of silicone rubber, based on the weight of the elastic handle.

18. The method of producing a grab bar assembly in claim 12, wherein the elastic handle contains about 2 wt % of silver ion based on the weight of the elastic handle.

19. The method of producing a grab bar assembly in claim 12, wherein the silicone rubber comprises dimethylpolysiloxane, dimethylvinylsiloxy-terminated organopolysiloxane gum and silanol-terminated organopolysiloxane oil.

20. The method of producing a grab bar assembly in claim 12, wherein at least a portion of the elastic handle has an exterior shape that is substantially helical.
